(19) United States
(12) Patent Application Publication
(10) Pub. No.: US 2003/0128274 A1
(43) Pub. Date: Jul. 10, 2003

(54) VIDEO MICROSCOPE APPARATUS

(75) Inventor: Thomas M. Dunn, Leawood, KS (US)

Correspondence Address: Thomas, Luebbering, Hovey Williams LLP, 2405 Grand Boulevard, Suite 400, Kansas City, MO, 64108, US

(73) Assignee: Ken-A-Vision Manufacturing Company, Inc., Kansas City, 64108 (US)

(21) Appl. No.: 09/492,562

(22) Filed: Jan. 27, 2000

(51) Int. Cl. H04N 7/18; H04N 9/47

(52) U.S. Cl. 348/79

(57) ABSTRACT

### Abstract of Disclosure

A video microscope (10) that can simultaneously display a video image on a TV monitor and a computer monitor so that the image can be received and "frozen,"recorded, or otherwise manipulated on the computer monitor while live action continues on the TV monitor. The video microscope includes a camera (12) for capturing an image and creating a corresponding signal; circuitry (14) coupled with the camera for receiving the signal and for creating an analog signal and a digital signal both corresponding to the signal; an analog output port (16) coupled with the circuitry and configured for coupling with a cable for delivering the analog signal to a TV monitor for displaying the image on the TV monitor; and a digital output port (18) coupled with the circuitry and configured for coupling with a cable for delivering the digital signal to a computer for displaying the image on a computer monitor.

### Background of Invention

### 1. FIELD OF THE INVENTION

The present invention relates to video cameras and microscopes. More particularly, the invention relates to a video microscope that captures an image of an object and creates a corresponding signal for simultaneous display on a TV monitor and a computer monitor.

### 2. DESCRIPTION OF THE PRIOR ART

Video microscope devices such as the Video Flex line manufactured and sold by Ken-A-Vision Manufacturing Company, Inc. of Kansas City, Missouri, allow educators, scientists, business people, and others to capture video images of objects and display the video images on TV monitors so that students and others may view magnified images of the objects. Such devices improve lectures, demonstrations, and experiments by allowing students and others to see objects "up close and personal." Moreover, because the devices are portable and easy to connect to a standard TV monitor, they can be used in almost any application where it is desirable to magnify and display a video image of an object.

Unfortunately, however, known prior art video microscopes are only operable to create analog video signals for displaying images on analog TV monitors and cannot create digital signals for displaying video images on computer monitors. Because many classrooms, offices, and labs now commonly use computers, the lack of a digital video signal decreases the utility of the devices.

This limitation can be partially overcome by coupling a prior art video microscope to an external analog-to-digital converter; however, this requires the use of additional external hardware that is somewhat difficult and time consuming to hook up. Moreover, when connected to an analog-to-digital converter, a video microscope can only be used to display video signals on a computer monitor or other similar digital device and cannot simultaneously display video images on a TV monitor. This is a disadvantage because it is often desirable to display video images simultaneously on both an analog TV monitor and a digital computer monitor.

### Summary of Invention

The present invention solves the above-described problems and provides a distinct advance in the art of video microscope devices. More particularly, the present invention provides a video microscope that can simultaneously display a video image on a TV monitor and a computer monitor so that the video signal can be received and "frozen,"recorded, or otherwise manipulated on the computer monitor while live action continues on the TV monitor. Moreover, the present invention allows such simultaneous display without the use of external converters and other hardware.

The video microscope of the present invention broadly includes a camera for capturing an image and creating a corresponding signal; circuitry coupled with the camera for receiving the signal and for creating an analog signal and a digital signal both corresponding to the signal; an analog output port coupled with the circuitry and configured for coupling with a cable for delivering the analog signal to a TV monitor for displaying the video image on the TV monitor; and a digital output port coupled with the circuitry and configured for coupling with a cable for delivering the digital signal to a computer for displaying the video image on a computer monitor.

In preferred forms, the digital output port is a universal serial bus (USB) port operable to connect with a corresponding USB port on a computer. The camera is preferably mounted to an elongated flexible neck that is in turn coupled with a base. The flexible neck and base permit the camera to be positioned in various orientations so that it may be used to capture video images of nearly any object.

These and other important aspects of the present invention are described more fully in the detailed description below.

### Brief Description of Drawings

A preferred embodiment of the present invention is described in detail below with reference to the attached drawing figures, wherein:Fig. 1 is an isometric view of a video microscope apparatus constructed in accordance with a preferred embodiment of the present invention.

Fig. 2 is an isometric view of the video microscope of Fig. 1 shown from a different angle.

Fig. 3 is a schematic block diagram of certain components of the video microscope.

### Detailed Description

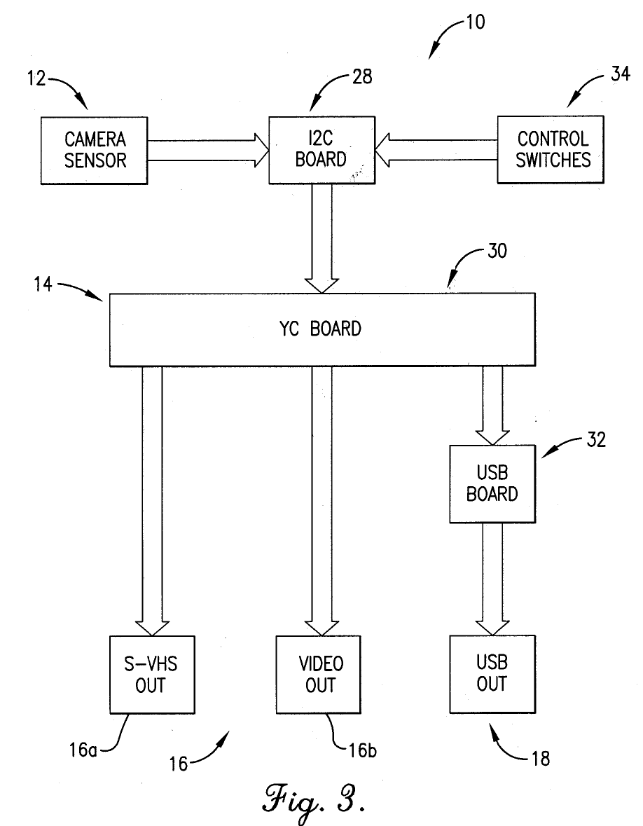

Turning now to the drawing figures, and particularly Fig. 3, a video microscope apparatus 10 constructed in accordance with a preferred embodiment of the invention is illustrated. The video microscope broadly includes a camera 12 for capturing an image and creating a corresponding signal; circuitry broadly referred to by the numeral 14 coupled with the camera for receiving the signal and for simultaneously creating an analog signal and a digital signal both corresponding to the signal; at least one analog output port 16 coupled with the circuitry and configured for coupling with a cable for delivering the analog signal to a TV monitor for displaying the video image on the TV monitor; and a digital output port 18 coupled with the circuitry and configured for coupling with a cable for delivering the digital signal to a computer for displaying the video image on a computer monitor.

In more detail, the camera 12 may be any conventional camera such as the ones used with the Video Flex line of video microscopes sold by Ken-A-Vision Manufacturing Company, Inc. As illustrated in Fig. 1, the camera is preferably coupled with an 8mm lens assembly 20 that permits magnification of the video image. The lens is C-mounted so that it is removable, allowing it to be replaced with other lenses. Conventional focusing mechanism 21 may be connected to the lens.

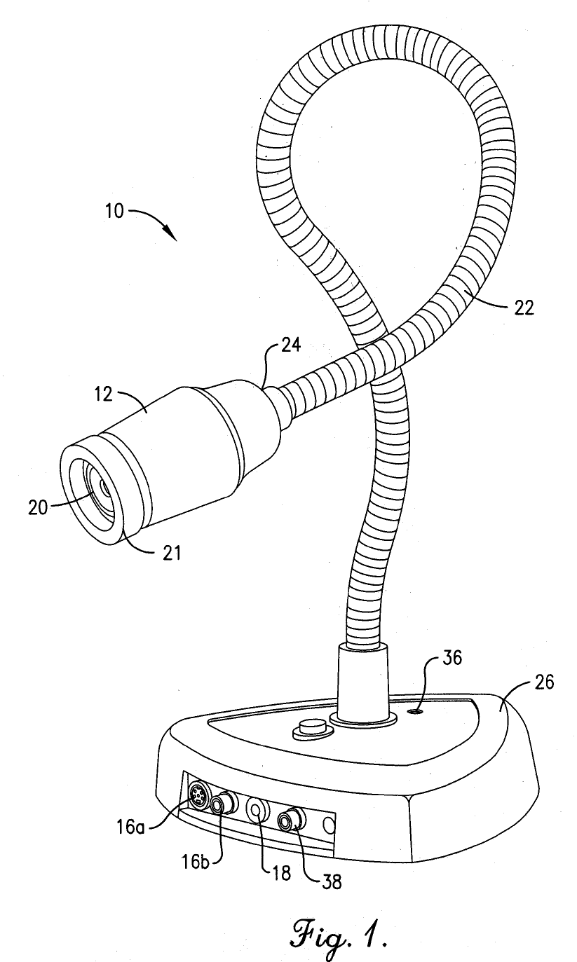

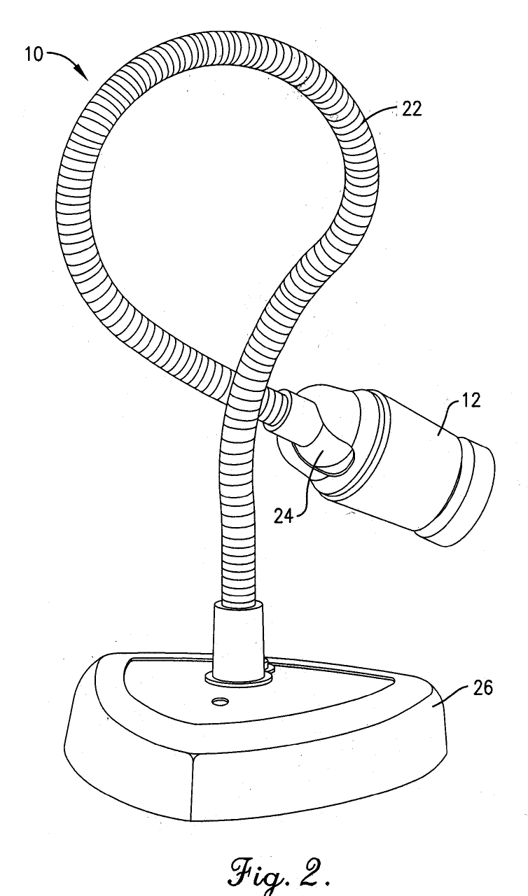

The camera 12 and lens 20 are preferably mounted to the end of an elongated flexible neck 22 by a ball and socket head 24 as best illustrated in Fig. 2. The neck is in turn connected to a base 26 that may be placed on a table, counter top or other flat surface. The flexible neck, base, and ball and socket head together permit the camera to be quickly and easily positioned to nearly any orientation so that it may be used to capture video images of nearly any object. The flexible neck, base, and ball and socket head are preferably the same as the components provided on the Video Flex line of video microscopes manufactured and sold by Ken-A-Vision Manufacturing Co., Inc.

Returning to Fig. 2, the circuitry 14 for creating the analog and digital signals includes an I2C board 28, a YC board 30, and a USB board 32. The I2C board is coupled with the camera 12 and provides digital enhancement of the images captured by the camera. Conventional control switches 34 may be coupled with the I2C board for controlling the enhancement of the images captured by the camera.

The YC board 30 is coupled with the I2C board 28 and simultaneously creates several balanced YC outputs including an S-VHS signal, a video signal, and a composite S-VHS and video signal. The signals are non-interfering so that each can be delivered to a different monitor or other end device as described below.

The composite S-VHS and video signals are delivered to the USB board 32. The USB board creates a digital computer signal from the composite S-VHS and video signals that is compatible with USB signaling. The USB board then delivers the digital signal to the digital output port 18.

The digital outport port 18 is preferably positioned on a rear face of the base 26 as illustrated in Fig. 1. The port is preferably a USB port operable to connect with a corresponding USB port on a computer or other digital device via conventional cabling. The USB port also serves to provide power to the entire video microscope apparatus.

The analog S-VHS signal and video signal are delivered to a pair of analog output ports 16. The analog output ports are preferably positioned on the rear face of the base 26 as illustrated in Fig. 1. The analog output ports may include both an S-VHS output port 16a and a video output port 16b. Both ports may be coupled with cabling for delivering analog S-VHS and video signals to an analog TV monitor or other analog device.

The video microscope 10 may also include a microphone 36 (Fig. 1) built into the base 26 for capturing audio signals. The microphone is in turn coupled with an audio output port 38 positioned on the rear face of the base for sending the audio signals to the speakers of a TV or computer.

In operation, the video microscope 10 of the present invention is first hooked up by attaching cabling between the S-VHS output port 16a and video output port 16b to a TV monitor and cabling between the USB output port 18 and a USB port of a computer. The camera 12 on the end of the flexible neck 20 is then positioned next to an object so that it captures an image of the object. The circuitry 14 receives the image and creates both an analog signal and a digital signal corresponding to the image and sends the analog signal to the TV monitor and the digital signal to the computer so that the video signal can be received and "frozen"on the computer monitor while live action continues on the TV monitor.

Although the invention has been described with reference to the preferred embodiment illustrated in the attached drawing figures, it is noted that equivalents may be employed and substitutions made herein without departing from the scope of the invention as recited in the claims.

Having thus described the preferred embodiment of the invention, what is claimed as new and desired to be protected by Letters Patent includes the following:

Claims

1. A video microscope apparatus comprising:
a camera for capturing an image and creating a corresponding signal;
circuitry coupled with the camera for receiving the signal and for creating an analog signal and a digital signal both corresponding to the signal;
an analog output port coupled with the circuitry and configured for coupling with a cable for delivering the analog signal to a TV monitor for displaying the image on the TV monitor; and
a digital output port coupled with the circuitry and configured for coupling with a cable for delivering the digital signal to a computer for displaying the image on a computer monitor.

2. The video microscope apparatus as set forth in claim 1, further including a lens assembly coupled with the camera for magnifying the image.

3. The video microscope apparatus as set forth in claim 1, the analog signal including a VHS signal.

4. The video microscope apparatus as set forth in claim 1, the analog signal including a S-VHS signal.

5. The video microscope apparatus as set forth in claim 1, the digital signal including a universal serial bus (USB) signal.

6. The video microscope apparatus as set forth in claim 1, further including a base and an elongated flexible neck coupled between the base and the camera for supporting the camera to the base.

7. A video microscope apparatus comprising:
a base;
a camera for capturing an image and creating a corresponding signal;
an elongated flexible neck having one end attached to the camera and another end attached to the base for supporting the camera to the base and for permitting the camera to be moved to a plurality of positions relative to the base;
circuitry coupled with the camera for receiving the signal and for creating an analog signal and a digital signal both corresponding to the signal;
an analog output port coupled with the circuitry and configured for coupling with a cable for delivering the analog signal to a TV monitor for displaying the image on the TV monitor; and
a digital output port coupled with the circuitry and configured for coupling with a cable for delivering the digital signal to a computer for displaying the image on a computer monitor.

8. The video microscope apparatus as set forth in claim 7, further including a lens assembly coupled with the camera for magnifying the image.

9. The video microscope apparatus as set forth in claim 7, the analog signal including a VHS signal.

10. The video microscope apparatus as set forth in claim 7, the analog signal including a S-VHS signal.

11. The video microscope apparatus as set forth in claim 7, the digital signal including a universal serial bus (USB) signal.
